(19) United States
(12) Patent Application Publication
(10) Pub. No.: US 2021/0130575 A1
(43) Pub. Date: May 6, 2021

(54) Polyolefin enhancement composition, & products made therewith

(71) Applicant: Quande Gui, Roseville, CA (US)

(72) Inventor: Quande Gui, Roseville, CA (US)

(21) Appl. No.: 16/602,564

(22) Filed: Oct. 31, 2019

(51) Int. Cl. C08K 5/057; C08K 5/05; C08K 5/20; C08J 5/18

(52) U.S. Cl. CPC C08K 5/057; C08K 5/05; C08J 2323/12; C08J 5/18; C08K 5/20

(57) ABSTRACT

A composition to improve the haze characteristic of polyolefins and to raise their crystallization temperature comprising:
a) a zinc or aluminum glycerolate,
b) a dispersing agent of the formula R—(OH)ₙ
wherein the (OH)ₙ of said dispersing agent is selected from ethylene glycol, propylene glycol, pentaerythritol, sorbitol, mannitol, glycerol, and other polyols wherein the R is a 2 to 10 carbon atom chain selected from alkyl, alkenyl, and alkynl, and the (OH)ₙ has at least two hydroxy groups,
   and a minor amount of calcium stearate, all to be added to a polyolefin homopolymer during the preparation of articles of polyolefin; as well as the actual polyolefin articles having the improved characteristics.

### FIELD OF THE INVENTION

This invention relates to polypropylene and an additive thereto to improve the clarity, and other physical properties of polypropylene manufactured products produced my molding, casting and other known processes. The additive is a two part composition of a finite amount of zinc or aluminum polyol complex and mixtures thereof, with a dispersing agent of the formula R—(OH)ₙ wherein the polyol is selected from ethylene glycol, propylene glycol, pentaerythritol, sorbitol, mannitol, glycerol and other polyols wherein the R is a 2 to 10 carbon atom chain selected from alkyl, alkenyl, and alkynl, and the (OH)ₙ has at least two hydroxy groups. Glycerol is also known as 1,2,3-propane triol. The compositions also enhance clarity of other polyolefin products

### BACKGROUND OF THE INVENTION

It has been known for many years that a glycerato-zinc complex of the formula (C₃H₆O₃Zn) can improve the physical properties of a polymeric composition. Thus U.S. Pat. No. 4,789,701 to Taylor, describes a method of modifying rubbers and plastics which consists of the steps of embodying into the rubber or plastic during manufacture, a glycerato-zinc complex of the formula shown above, by heating a zinc compound and glycerol below glycerol's boiling point, to form two dimensional crystals of a hexagonal morphology, and then arranging the crystals in the rubber or polymer to improve tensile strength, and UV light degradation.

Michael Bos, an Australian, in his U.S. Pat. No. 7,074,949 describes a method of producing zinc-glycerolate, by reacting hydrozincite or zinc oxide produced a certain way, namely by calcining hydrozincite, either with or without a dispersing agent, which agent would be selected from among fatty acids, fatty acid esters, and other polymeric dispersants. He then uses the zinc glycerolate in the formation of polymeric compositions wherein the polymer is any of PE, PP, PVC, polystyrene, polyester, polyamide, and A-B-S. His ratio of polymer to zinc compound can range from 10:1 TO 1:10.

A third patent reviewed is that of Hild et al U.S. Pat. No. 7,746,713. This patent pertains to the addition of a polyhydroxyl alcoholate of a divalent metal which can be any of zinc, calcium, cobalt, boron, manganese, iron, magnesium, titanium or copper, and more particularly zinc glycerolate, in an amount of 0.01% to 5.0%, to a polyolefin. More particularly he adds his composition to a polypropylene homopolymer or a polypropylene copolymer. He also adds one or more conventional additives and an organic pigment during the formation of the consumer product such as kitchen appliance body. Clearly he is not concerned about translucency or haze. His thrust is resistance against anisotropic shrinkage.

Now let us deviate from the prior art to a discussion of some important terminology that relates to the production of polymeric products. Nucleating agents promote the crystallization of semi-crystalline polymers. These additives function by presenting a heterogeneous surface to the polymer melt, making the crystallization process more thermodynamically favorable. As a result of the this effect, the temperature at which the polymer begins to crystallize from the melt is increased, as are the rate of nucleation and overall rate of crystallization. Nucleating agents also promote the formation of more and smaller spherulites, which often brings about enhanced properties such as flexural modulus and heat deflection temperature (HDT). Nucleating agents are most widely used in polypropylene (homo- and random co-polymers), where they provide three main benefits: property enhancement, improved molding productivity, and increased transparency. When employed for the reduction of haze, as by helping to produce spherulites so small that they do not scatter visible light, thereby providing transparent polypropylene, the nucleating agents are referred to as clarifiers (or clarifying agents). Thus one can find in the marketplace both clarifying agents for polypropylene and nucleating agents for polypropylene for both high and low melt flow polymers.

Thus in the prior art, zinc glycerolate has been regarded by scientists as a nucleator and not as a clarifier, primarily because zinc glycerolate itself is insolouble in polyolefins. Nucleators do not disperse as easily as clarifiers since most are inorganic compositions with no solubility in the resin. These inorganic nucleators rely on dispersion by mechanical methods to nucleate poly propylene (PP) in order to form the small spherulites. Spherulites are spherical semicrystalline regions inside non-branched linear polymers whose formation is associated with crystallization of polymers from the melt and is controlled by several parameters such as the number of nucleation sites, structure of the polymer molecules, cooling rate, etc It is also known that when the inorganic nucleators are compounded into the polymer, they provide additional sites for nucleation and thus the spherulites become smaller in size.

A “Nucleator” is typically characterized as an insoluble particulate that increases the rate of crystallization. When semi-crystalline polymers crystallize from the melt (typically during the cooling phase of a process), the lamellae organize from a primary nucleus to form complex macro-structures called spherulites. These spherulites continue to grow until they impinge on an adjacent spherulite at which point the growth ceases. Properties of the polymers, including optical and physical characteristics depend on the end size of the spherulite structures and the crystalline orientation in the matrix. In nucleated polypropylene, crystallization occurs earlier in the cooling process and happens at a faster rate. This allows decreased cooling time of the polymer. Also, nucleation density is much higher and crystal spherulite size is much smaller.

Now we are getting to the present invention. This invention utilizes an aluminum or preferably zinc alcohoate in combination with another composition to act as a clarifier for polypropylene and other polyolefin products. Haze has been shown to have been reduced in products produced in accordance with this invention.

For a fuller understanding of the nature and objects of the invention, reference should be made to the following detailed description and the claims appended there after.

### SUMMARY OF THE INVENTION

The present invention relates to a composition that includes a divalent metal poly hydroxy alcoholate. More particularly the invention relates to the use of aluminum and zinc glycerolates with a dispersing agent in the production of polypropylene items to reduce haze and enhance transparency. The dispersing agent is of the formula R₂—C₁₋₄—X wherein X is —OH, —COOH, or —COOR, wherein R₂ is from 4 to about 50 carbon atoms; and the dispersing agent is utilized in a weight ratio of 5:90 to about 40:60 with the divalent metal polyhydroxy alcoholate. The most preferred compound is zinc glycerolate for the alcoholate, and the dispersant is selected from among quite a few; namely octadecyl alcohol, stearic acid, erucic acid amide, glyceryl mono and bi stearates, glyceryl monoglyceride, glyceryl beetate, sorbitol esters, mannitol, and various fatty acids such as the Spans which include among others, sorbitan monostearate, (C₂₄H₄₆O₆).

It is a first object to prepare by reacting zinc or aluminum and mixtures thereof with a divalent metal poly hydroxy alcohol to form an alcholate.

A second object of the invention is to from zinc glycerolate from the reaction of zinc with glycerol, by a known means.

A third object is to combine zinc glycerolate with a dispersant for the clarification of polyolefins.

A fourth object is to produce improved polypropylene items having reduced haze and increased transparency.

The fifth object of this invention is to improve the crystallization temperature of polyolefins, since the crystallization temperature is considered to be a major indicator of the nucleating efficiency of a nucleating agent.

The sixth object is provide a composition based on a zinc alcoholate and a dispersant, that unexpectedly improves the clarification of polypropylene.

The seventh object is to improve the crystallization temperature of polypropylene.

Other objects of the invention will in part be obvious and will in part appear hereinafter.

The invention accordingly comprises the process possessing the series of steps, and combination of elements, as well as the product of the process, all of which are exemplified in the following detailed disclosure, and the scope of the application of which will be indicated in the claims.

### DESCRIPTION OF THE PREFERRED EMBODIMENT

The present invention relates to a divalent metal alcoholate complex, more particularly zinc glycerolate or aluminum glycerolate used with a dispersant to improve the clarity of polypropylene compositions. In the past the glycerolate has only been used as a nucleating agent, the definition of which appears supra. This is true even if the particle size is ultra-fine of less than 100 nanometers. See U.S. Pat. No. 7,074,949, where it was shown to enhance or increase the dimensional stability of polypropylene items.

Whereas sorbitol based clarifying agents such as Millad NX 8000 of Milliken Chemical of Spartanburg S.C., can be dissolved in PP (polypropylene) to act as such—as defined supra, zinc glycerolate can not be dissolved in PP. Furthermore zinc glycerolate has a relatively high melting point. Plus, zinc glycerolate crystals will re-aggregate during transportation and/or storage. Thus this compound is NOT considered by the industry to be a clarifier for PP. However the present invention defines a composition which enables zinc glycerolate to achieve excellent dispersion in PP, thereby unexpectedly greatly improving the transparency—a highly desired property for PP.

The composition of this invention consists of two compounds, the zinc or aluminum glycerolate and mixtures thereof, AND a saturated or unsaturated C₄ to C₅₀ carbon chain alcohol, carboxylic acid or carboxylic acid ester, which is the dispersant and is designated as the second component. Typical dispersant agents include octadecyl alcohol, stearic acid, erucic acid amide, glyceryl mono and bi stearates, glyceryl monoglyceride, glyceryl beetate, sorbitol esters, mannitol, and various fatty acids such as the Spans which include among others, sorbitan monostearate, (C₂₄H₄₆O₆).

When this 2 part composition is used, to enhance the properties of PP. the glycerolate is added in a 50% to 95% by weight or preferably in the 70% to 95% by weight of the 2 component composition. The addition of the composition of this invention to the PP melt may be within the range of about 100 to 10,000 PPM, with an addition of 200 to 2000 PPM giving the best results.

When the compositions of this invention is added to PP melt, haze is reduced and transparency increased. If one desires to add this composition to a sorbitol based clarifying agent, one may do so to speed up the rate of nucleation while maintaining the desired improved transparency of the end products to be produced.

The following non-limiting examples are set out for better understanding of the invention Table 1 illustrates in table format the reagents used to prepare the zinc glycerolate forming part of the composition of this invention as called out in section 1 A of the table). It is believed that when Aluminum oxide is substituted for the zinc oxide, aluminum glycerolate will be similarly prepared.

In section 1 b) of the table the long chain alcohol, long chain amide or long chain carbocyclic acid ester component, that forms the second part of the composition is set forth.

TABLE 1

| | 1 a) | | | | 1b) | | | | | | | |
|---|---|---|---|---|---|---|---|---|---|---|---|---|
| | Zinc source | | polyol | | Alcohol | | Amide | | Carboxylic acid esteer | | catelyzer | |
| example 1 | hydrozincite | 1500 | Glycerol | 1230 | — | — | — | — | — | — | Acetic | 20 |
| (control) | | | | | | | | | | | | |
| example 2 | hydrozincite | 1500 | Glycerol | 1230 | — | — | — | — | Glycerol | 300 | Acetic | 20 |
| | | | | | | | | | monostearate | | | |
| example 3 | Zinc oxide | 1276 | Glycerol | 1230 | — | — | — | — | Glycerol | 300 | Acetic | 20 |
| | | | | | | | | | monostearate | | | |
| example 4 | hydrozincite | 1500 | Glycerol | 1230 | — | — | — | — | Span 60 | 300 | Acetic | 20 |
| example 5 | hydrozincite | 1500 | Glycerol | 1230 | Octadecan- | 300 | — | — | — | — | Acetic | 20 |
| | | | | | 1-ol | | | | | | | |
| example 6 | Zinc oxide | 1276 | Glycerol | 1230 | — | — | — | — | Glycerol | 50 | Acetic | 20 |
| (control) | | | | | | | | | monostearate | | | |
| example 7 | hydrozincite | 1500 | propane- | 998 | — | — | — | — | Glycerol | 300 | Acetic | 20 |
| | | | 1,2-diol | | | | | | monostearate | | | |
| example 8 | hydrozincite | 1500 | Mannitol | 1120 | — | — | — | — | Glycerol | 350 | Acetic | 20 |
| | | | | | | | | | monostearate | | | |
| example 9 | hydrozincite | 1500 | Glycerol | 1230 | | — | Erucamide | 300 | | | Acetic | 20 |
| example 10 | hydrozincite | 1500 | Glycerol | 1230 | — | — | — | — | Span 60 | 200 | Acetic | 20 |
| example 11 | Zinc oxide | 1276 | Glycerol | 1230 | — | — | — | — | Pentaerythritol | 350 | Acetic | 20 |
| | | | | | | | | | monostearate | | | |
| example 12 | hydrozincite | 1500 | Glycerol | 1230 | — | — | — | — | Pentaerythritol | 300 | Acetic | 20 |
| | | | | | | | | | Distearate | | | |

### Example 1 Manufacture of Zinc Glycerolate Only

1230 g glycerol and 20 g acetic acid were added to a 2-liter kneader with a Z arm and heated to 70° C., and 1500 g hydrozincite was added while keeping up the stirring. Then the slurry was raised to 150° C. rapidly and kept at this temperature for 12 hours with continual stirring. The reaction mixture was reacted from slurry to a white flowing powder, and the white powder was taken out of the mixture and weighed at a weight of 2050 t and then crushed with a jet mill. The melting point of the composition is above 300° C.

### Manufacture of the Total Composition of this Invention

### Example 2

1230 g glycerol, 300 g glycerol monostearate and 20 g acetic acid were added to a 2-liter kneader with a Z arm and heated to 70° C. Then 1500 g of hydrozincite was added while keeping up the stirring. Then the slurry was raised to 150° C. rapidly and kept at this temperature for 12 hours with continued stirring. The reaction mixture was reacted from slurry to a white flowing powder, and the white powder was taken out and found to weigh 2340 g and it is then crushed with a jet mill. The melting point was taken and found to be above 300° C.

### Example 3

1230 g glycerol, 300 g glycerol monostearate and 20 g acetic acid were added to a 2-liter kneader with a Z arm and heated to 70° C. Then 1276 g ZnO was added with constant stirring. Then the slurry was raised to 15.0° C. rapidly and kept there for 12 hours while continuing stirring. The reaction mixture was reacted from slurry to a white flowing powder, and the white powder was removed and weighted in at a weight of 2720 g. The powder was crushed with a jet mill into fine particles. The melting point is above 300° C.

### Example 4

1230 g glycerol, 300 g Span-80 and 20 g acetic acid were added to a 2-liter kneader of with a Z arm and heated to 70° C., and then 1276 g ZnO was added with stirring. Then the slurry was raised to 150° C. rapidly and kept at this temperature for 12 hours while keeping up the stirring. The reaction mixture was reacted from slurry to a white flowing powder, and the white powder was removed and found to have a weight of 2700 g. The powder was crushed with a jet mill. The melting point is above 300° C.

### Example 5

1230 g glycerol, 300 g octadecan-1-ol and 20 g acetic acid were added to 2-liter kneader with a Z arm and heated to 70° C., and 1500 g hydrozincite was added while keeping up the stirring. Then the slurry was raised to 150° C. rapidly and kept at that temperature for 12 hours with constant stirring. The reaction mixture was reacted from a slurry to a white flowing powder, and the white powder was taken out, weighed and found to have a weight of 2750 g. The powder was crushed with a jet mill. The melting point is above 300° C.

### Example 6 Control

1230 g glycerol, 50 g glycerol monostearate and 20 g acetic acid were added to 2-liter kneader with a Z arm and heated to 70° C., and 1500 g hydrozincite was added while keeping up the stirring. Then the slurry was raised to 150° C. rapidly and held there for 12 hours while keeping up the stirring. The reaction mixture was reacted from a slurry to a white flowing powder, and the white powder was removed and found to have a weight of 2750 g prior to being crushed with a jet mill. The melting point is above 300° C.

### Example 7

1230 g glycerol, 300 g glycerol monostearate and 20 g acetic acid were added to a 2-liter kneader with a Z arm and heated to 70° C., and 998 g propane-1,2-diol was added while keeping up the stirring. Then the slurry was raised to 150° C. rapidly and held at this temperature for 12 hours while under constant stirring. The reaction mixture was reacted from slurry to a white flowing powder, and the white powder was taken out and found to have a weight of 2750 g prior to it being crushed with a jet mill. The melting point is above 300° C.

### Example 8

1120 g Mannitol, 350 g glycerol monostearate and 20 g acetic acid were added to a 2-liter kneader with a Z arm and heated to 70° C. Then 1500 g hydrozincite was added while keeping up the stirring. Then the slurry temperature was raised to 150° C. rapidly and retained at that temperature for 12 hours under constant stirring. The reaction mixture was reacted from slurry to a white flowing powder, and the white powder was taken out and found to have a weight of 2750 g. The powder is then crushed with a jet mill. The melting point is above 300° C.

### Example 9

1230 g glycerol, 300 g Erucamide which is the amide of docosenoic acid, and 20 g acetic acid were added to a 2-liter kneader with a Z arm and heated to 70° C., and 1500 g hydrozincite was added while keeping up the stirring. Then the slurry was raised to 150° C. rapidly and retained at this temperature for 12 hours under continual stirring. The reaction mixture was reacted from slurry to a white flowing powder, and the white powder was removed and found to have a weight of 2750 g prior to being crushed with a jet mill. The melting point is above 300° C.

### Example 10

1230 g glycerol, 200 g Span@ 60 and 20 g acetic acid were added to a 2-liter kneader with a Z arm and heated to 70° C., and 1500 g hydrozincite was added with continual stirring. Then the slurry was raised to 150° C. rapidly and kept there for 12 hours while keeping up the stirring. The reaction mixture was reacted from slurry to a white flowing powder, and the white powder was removed, weighed, with a weight of 27.50 g and then crushed with a jet mill. The melting point is above 300° C.

### Example 11

1230 g glycerol, 350 g pentaerythritol monostearate, and 20 g acetic acid were added to a 2-liter kneader with a Z arm and heated to 70° C., and then 1276 g zinc oxide was added while keeping up the stirring. Then the slurry was raised to 150° C. rapidly and kept at this temperature white flowing powder. The white powder was separated, and found to have a weight of 2750 g prior to being crushed with a jet mill. The melting point is above 300° C.

### Example 12

1230 g glycerol, 300 g pentaerythritol distearate and 20 g acetic acid were added to a 2-liter kneader with a Z arm and heated to 70° C. Then 1500 g hydrozincite was added with stirring. Then the slurry was raised to 150° C. rapidly and kept there for 12 hours while keeping up the stirring. The reaction mixture was reacted from slurry to a white flowing powder, and the white powder was taken out and found to have a weight of 2750 g. The powder was crushed with a jet mill. The melting point is above 300° C.

Span®60 is Sorbitan monostearate; and Span®80 is sorbitan oleate. Both are dispersants sold by Aldrich chemical.

Measurement and Production of Nucleated Polyolefins with the Inventive Compositions

The polypropylene resin (INEOS PP HOMO H03G-00)^{(A)} 1000 g; the Irganox brand B-215^{(B)} of antioxidant from BASF, 0.1 g; the acid absorbent (calcium stearate) 0.05 g; and, the nucleating agent prepared in the examples 2-12 above, were mixed together in a high-speed mixer according to the formulations set forth in Table 2, followed by extrusion granulation using a co-rotating twin-screw extruder at an extrusion temperature of 200 Celsius degrees. The extruded material was injected into a 51 mm×76 MM×1.27 mm sheet mold in an injection molding machine at 200-230 Celsius degrees. After the molded sheet(s) have been dried for 48 hours under standard conditions, the haze of these samples was measured according to ASTM D1003. The results are also reported in Table 2 furthest right column. ^{(A)} H03G-00 is a general purpose homopolymer polypropylene designed for extrusion applications including carpet backing, fiber and tape, rope and cordage, fiber bags, and twine. It has an ASTM of D792 and a melt flow rate at 230 degrees C./2.16 kg of D1238, again by ASTM method.^{(B)} Irganox B-215 is a blend of 67% IRGAFOS 168 of the formula Tris(2,4-di-tert-butylphenyl) phosphite; with 33% IRGANOX 1010 of the formula Pentaerythritol tetrakis(3-(3,5-di-tert-butyl-4-hydroxyphenyl)propionate) which have molecular weights 646.9 and 1178 respectively.

Crystallization temperature (Tc) is an important indicator to measure the crystallization efficiency of a nucleating agent. The crystallization temperature of the sample is generally measured by DSC. The addition of nucleating agents can effectively improve the crystallization temperature of polypropylene, speed up the crystallization rate, thus shortening the injection cycle. The test standard for measuring the crystallization temperature of the polymer is ASTM D792. To measure the crystallization temperature, it is necessary to add the target polymer from 200° C. to 220° C. at a rate of 10° C./min for 2 min and then to 10 Degree/min down to 60 degrees C. The peak of the crystallization enthalpy, corresponds to the temperature recited as the crystallization temperature result for each sample as are reported in Table 2. Note the lower haze measurement and higher crystallization temperatures from this invention.

TABLE 2
Amount = Polypropylene 1000 g, antioxidant
0.1 g, CaStearate 0.05 g; for all 24 examples.

| | Sample | | | | |
|---|---|---|---|---|---|
| | from Ex. 1- | | FORMULATION | | Haze |
| | 12 Table1 | | AMOUNT | Tc | Measurement |
| A | 1- 1 | g Con | AMOUNT | 128 | 32 |
| B | 1-4 | g Con | AMOUNT | 130 | 44 |
| C | 2-1 | g | AMOUNT | 133 | 14 |
| D | 2-4 | g | AMOUNT | 134 | 14 |
| E | 3-1 | g | AMOUNT | 132 | 15 |
| F | 3-4 | g | AMOUNT | 133 | 17 |
| G | 4-1 | g | AMOUNT | 133 | 14 |
| H | 4-4 | g | AMOUNT | 136 | 15 |
| I | 5-1 | g | AMOUNT | 132 | 19 |
| J | 5-4 | g | AMOUNT | 135 | 24 |
| K | 6-1 | g Con | AMOUNT | 128 | 31 |
| L | 6-4 | g Con | AMOUNT | 132 | 36 |
| M | 7-1 | g | AMOUNT | 132 | 19 |
| N | 7-4 | g | AMOUNT | 135 | 21 |
| O | 8-1 | g | AMOUNT | 131 | 24 |
| P | 8-4 | g | AMOUNT | 133 | 27 |
| Q | 9-1 | g | AMOUNT | 132 | 16 |
| R | 9-4 | g | AMOUNT | 134 | 17 |
| S | 10-1 | g | AMOUNT | 133 | 14 |
| U | 10- 1 | g | AMOUNT | 136 | 15 |
| V | 11-1 | g | AMOUNT | 132 | 17 |
| W | 11-4 | g | AMOUNT | 133 | 19 |
| X | 12-1 | g | AMOUNT | 133 | 16 |
| Y | 12-4 | g | AMOUNT | 135 | 21 |

Con = control

### CONCLUSIONS

Haze measurements are understood to be the smaller number the better in the standardized test, as that means that more light gets through if the haze is smaller.

It is seen from a comparison of Examples (A) and (B) that when 1 g and 4 grams of just the glycerolate was added to the PP that the haze rating was 32 and 44. And for all other non-control Examples of Table 1 wherein the composition of this invention were added to the PP, the haze measurements were from a low of 14 for a 1 gram sample to a high of 27 for a 4 gram sample. The measurements for the two control samples of Example 6 in Table 1, were 31 and 36 respectively.

Thus for the A-J examples, when the inventive composition is used in a 1 gram amount, the haze rages from 14 to 19 versus 32 with just the zinc glycerolate. When 4 grams of the new composition was used the haze improvement was from 14-24 versus a whopping 44 with just the zinc glycerolate. Similar improvements are seen in the haze measurements, i.e. clarity, for examples M through W versus the controls, K and L.

The temperature of crystallization are higher for both 1 and 4 gram samples of the additive compositions of this invention are measured, compared with the 4 control samples, A.B., K and L of Table 2.

One can thereafter appreciate the benefits to be gained from using the new compositions of this invention as a nucleating-clarifying agent versus the prior art of just using zinc or aluminum glycerolate. It has been demonstrated that the inventive compositions of this application provide both very high crystallization temperature and excellent transparency of polypropylene articles made using these compositions.

Since certain changes may be made in the above compositions without departing from the scope of the invention herein involved, it is intended that all matter contained in the above description, shall be interpreted as illustrative only and not in a limiting sense.

I claim:

1. A new composition of matter to enhance the clarity of polyolefins which comprises:
a) a zinc or aluminum glycerolate and mixtures thereof, and
b) a dispersing agent of the formula R—(OH)ₙ
wherein the (OH)ₙ of said dispersing agent is selected from ethylene glycol, propylene glycol, pentaerythritol, sorbitol, mannitol, glycerol, and other polyols wherein the R is a 2 to 10 carbon atom chain selected from alkyl, alkenyl, and alkynl, and the (OH)ₙ has at least two hydroxy groups.

2. A composition to lower the ASTM haze measurement and increase the crystallization temperature of polypropylene articles which comprises:
a) at least one zinc-polyol complex as a nucleating agent,
b) at least one dispersing agent, selected from the group consisting of alcohols, amides, and carboxylic acid esters, each having a carbon chain of 4 to 50 carbon atoms and
wherein said dispersing agent is provided in a weight ratio to nucleating compound of from about 5:90 to about 40:60.

3. The composition of claim 2 wherein each said polyol used to react with zinc has at least two hydroxy groups, and is used alone or in mixtures thereof.

4. The composition of claim 1 wherein the dispersing agent has a carbon chain selected from the group consisting of alkyl, alkenyl, and alkynyl.

5. The composition of claim 1 wherein said dispersant is an alcohol and is selected from the group consisting of mono-alcohols and polyols having 4 to 50 carbon atoms.

6. The composition of claim 2 wherein said dispersing agent is an organic amide having at least amide group.

7. The composition of claim 2 wherein the a) component is zinc-glycerolate.

8. The composition of claim 2 wherein said dispersing agent is an organic carboxylic acid ester that contains at least one or esteryl group.

9. The composition of claim 2 wherein component b) is octadecan-1-ol.

10. The composition of claim 7 wherein the component b) is erucamide

11. The composition of claim 2 wherein the component b) is selected from the group consisting of pentaerythritol monostearate and pentaerythritol distearate and the a) compound is selected from the group consisting of zinc oxide and hydrozincite pre-reacted with glycerol.

12. The composition of claim 2 further including a minor amount of calcium stearate.

13. A composition for lowering the haze characteristic measurement and raising the crystallization temperature of polypropylene articles which comprises extruding the polypropylene with a mixture of zinc glycerolate, a minor amount of calcium stearate and a dispersing agent, selected from the group consisting of alcohols, amides, and carboxylic acid esters, each having a carbon chain of 4 to 50 carbon atoms and
wherein said dispersing agent is provided in a weight ratio to the zinc glycerolate of from about 5:90 to about 40:60.

14. A polyolefin article having an improved haze characteristic and a higher crystallization temperature formed from a composition prepared from a polyolefin and at least 0.01-5% weight of the composition of
a) a zinc or aluminum glycerolate and mixtures thereof, and
b) a dispersing agent of the formula R—(OH)ₙ
wherein the (OH)ₙ of said dispersing agent is selected from ethylene glycol, propylene glycol, pentaerythritol, sorbitol, mannitol, glycerol, and other polyols wherein the R is a 2 to 10 carbon atom chain selected from alkyl, alkenyl, and alkynl, and the (OH)ₙ has at least two hydroxy groups and the dispersing agent is utilized in a weight ratio of 5:90 to about 40:60 with the glycerolate.

15. The polyolefin article of claim 14 where the olefin is polypropylene, and a minor amount of calcium stearate is added to the composition of
a) a zinc glycerolate, and
b) a dispersing agent of the formula R—(OH)ₙ
wherein the (OH)ₙ of said dispersing agent is selected from ethylene glycol, propylene glycol, pentaerythritol, sorbitol, mannitol, glycerol, and other polyols wherein the R is a 2 to 10 carbon atom chain selected from alkyl, alkenyl, and alkynl, and the (OH)ₙ has at least two hydroxy groups.

16. The polyolefin article of claim 15 wherein the dispersing agent is selected from the group consisting of glycerol and pentaerythritol monostearate and distearates.

17. The polyolefin article of claim 15 wherein the dispersing agent is selected from the group consisting of Erucamide and octadecan-1-ol.

18. A sheet polypropylene article having an ASTM D1003 haze measurement of between 14 and 27 prepared from a composition comprising zinc glycerolate, a dispersing agent having terminal alcohol, amide or carboxylic acid ester groups, and a minor amount of calcium stearate.
